(19) United States
(12) Patent Application Publication
(10) Pub. No.: US 2007/0114856 A1
(43) Pub. Date: May 24, 2007

(54) Soft magnetic powder-based stator for use in motor

(75) Inventor: Jin Hyung Park, Seoul (KR)

Correspondence Address: BACON & THOMAS, PLLC, 625 SLATERS LANE, FOURTH FLOOR, ALEXANDRIA, VA, 22314, US

(73) Assignee: DAEWOOD ELECTRONICS CORPORATION, Seoul (KR)

(21) Appl. No.: 11/603,004

(22) Filed: Nov. 22, 2006

(30) Foreign Application Priority Data
Nov. 23, 2005 (KR) 10-2005-0112299

(51) Int. Cl. H02K 15/12; H02K 1/28; H02K 1/12

(52) U.S. Cl. 310/44; 310/218; 310/259

(57) ABSTRACT

A stator for use in a motor, being wound with a coil, includes a main body fixed to a inside of the motor; a plurality of teeth formed to be integrated with the main body and respectively wound with the coil; gap reducers, each of which being formed on upper and lower surfaces of each of the teeth and protruding in a direction to decrease gaps between an upper surface of each of the teeth and the coil and between a lower surface of each of the teeth and the coil; and punch damage barriers, each of which having plane surfaces extending to both sides of each of the gap reducers and connected to both sides of each of the teeth. Further, the stator is manufactured by pressing soft magnetic powder.

### FIELD OF THE INVENTION

The present invention relates to a soft magnetic powder-based stator for use in a motor, and more particularly, to a soft magnetic powder-based stator for use in a motor, wherein the stator is advantageous of improving performance of a motor and decreasing an amount of a coil used by reducing gaps each between a corresponding tooth and a coil, and of minimizing damage to parts of a manufacturing equipment.

### BACKGROUND OF THE INVENTION

In general, a motor is a device that converts electrical energy into mechanical energy to provide a rotational force. Motors are being widely applied to various industrial fields including electric home appliances and industrial machines. For instance, motors can be applied to compressors, which are installed inside cooling appliances such as air conditioners and refrigerators to restore a refrigerant to a liquid, washing machines, vacuum cleaners, optical disk players, and hard disk drivers of computers.

With reference to FIG. 1, a conventional motor will be descried hereinafter.

FIG. 1 illustrates a sectional view of a conventional motor 10. The illustrated conventional motor 10 is one exemplary direct current (DC) motor, more particularly, a brushless direct current (BLDC) motor that drives using a non-contact type position detector and a semiconductor device instead of a brush. The conventional motor 10 includes holders 11 and 12, bearings 11a and 12a, a casing 13, a stator 14, teeth 14b (refer to FIG. 2), an insulator 14a, a coil 14c, a rotor 15, a plurality of magnets 15a, and a rotational shaft 16. The holders 11 and 12 are attached individually to the casing 13 on upper and low sides. In the stator 14, the teeth 14b are affixed to the inner surface of the casing 13 and insulated by the insulator 14a, and the coil 14c is wound around the teeth 14b. The rotor 15 is installed inside the stator 14 by having a gap therebetween. The magnets 15a are inserted into and affixed to the outer surface of the rotor 15. The rotor 15 rotates due to reciprocal reactions between the magnets 15a and a magnetic field produced at the stator 14. The rotational shaft 16 is affixed to a central part of the rotor 15 and installed to be rotatable by means of the bearings 11a and 12a of the respective holders 11 and 12.

Referring to FIG. 2, the teeth 14b of the stator 14 are spaced apart a certain distance from each other along the inner surface of the stator 14 to form a plurality of slots 14e inside the stator 14.

As similar to the rotor 15, the conventional stator 14 for use in a motor is formed by stacking a plurality of silicon steel sheets 14d (refer to FIG. 3) over each other. As illustrated in FIG. 3, the teeth 14b are formed in a quadrature shape from a sectional view. That is, each of the teeth 14b has upper and lower surfaces 14f and 14g and two side surfaces 14h in straight lines. Thus, the sectional view of the teeth 14b is inevitably in a quadrature shape since the stator 14 is manufactured by stacking the multiple silicon steel sheets 14d over each other.

However, since the teeth 14b of the conventional stator 14 has the quadrature shape from the sectional view, as illustrated in FIG. 4, the coil 14c wound around the teeth 14b insulated by the insulator 14a generates gaps G on the surfaces of the teeth 14b, particularly, the upper and lower surfaces 14f and 14g. The gaps G often cause reduction in the performance of the motor 10 and increase in an amount of the coil 14c wound around the individual teeth 14b. As a result, the loss of the coil 14c may be accelerated.

### SUMMARY OF THE INVENTION

It is, therefore, an object of the present invention to provide a soft magnetic powder-based stator for use in a motor, wherein the stator can prevent reduction in performance of a motor by reducing gaps each between a corresponding tooth and a coil, reduce manufacturing costs by decreasing an amount of the coil used, provide a lightweight motor through weight reduction, and minimize damage to parts of a manufacturing equipment.

In accordance with a preferred embodiment of the present invention, there is provided a stator for use in a motor. The stator is wound with a coil. The stator includes a main body fixed to the inside of the motor, a plurality of teeth formed to be integrated with the main body and respectively wound with the coil, gap reducers, each of which being formed on upper and lower surfaces of each of the teeth and protruding in a direction to decrease gaps between the upper surface of each of the teeth and the coil and between the lower surface of each of the teeth and the coil, and punch damage barriers, each of which having plane surfaces extending to both sides of each of the gap reducers and connected to both sides of each of the teeth.

Preferably, the teeth are formed to have indentations lengthwise on the upper and lower surfaces of the teeth to decrease a volume of the teeth.

Preferably, each of the gap reducers is formed in an arc shape to protrude.

Preferably, each of the gap reducers is formed to protrude by connecting a straight-line surface portion of each of the gap reducers with curved-line surface portions of each of the gap reducers.

Preferably, each of the gap reducers is formed to protrude by connecting straight-line surface portions of each of the gap reducers with each other.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a sectional view of a conventional motor;

FIG. 2 illustrates a top view of a stator for use in the conventional motor;

FIG. 3 illustrates a sectional view of the stator taken along a line A-A′ illustrated in FIG. 2;

FIG. 4 illustrates a sectional view of the conventional stator to describe limitations thereof;

FIG. 5 illustrates a sectional view of a motor in accordance with an embodiment of the present invention;

FIG. 6 illustrates a top view of a stator used in a motor and formed of soft magnetic powder material in accordance with a first exemplary embodiment of the present invention;

FIG. 7 illustrates a sectional view of the stator taken along a line B-B′ illustrated in FIG. 6;

FIG. 8 illustrates a sectional view of the stator taken along a line C-C′ illustrated in FIG. 6;

FIG. 9 illustrates a sectional view to describe the working of the soft magnetic powder-based stator for use in the motor in accordance with the first exemplary embodiment of the present invention;

FIG. 10 illustrates a sectional view to describe the working of a soft magnetic powder-based stator for use in a motor in accordance with a second exemplary embodiment of the present invention;

FIG. 11 illustrates a sectional view to describe the working of a soft magnetic powder-based stator for use in a motor in accordance with a third exemplary embodiment of the present invention; and

FIGS. 12A and 12B illustrate sectional views to describe the working of the soft magnetic powder-based stator for use in the motor in accordance with other exemplary embodiments of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art.

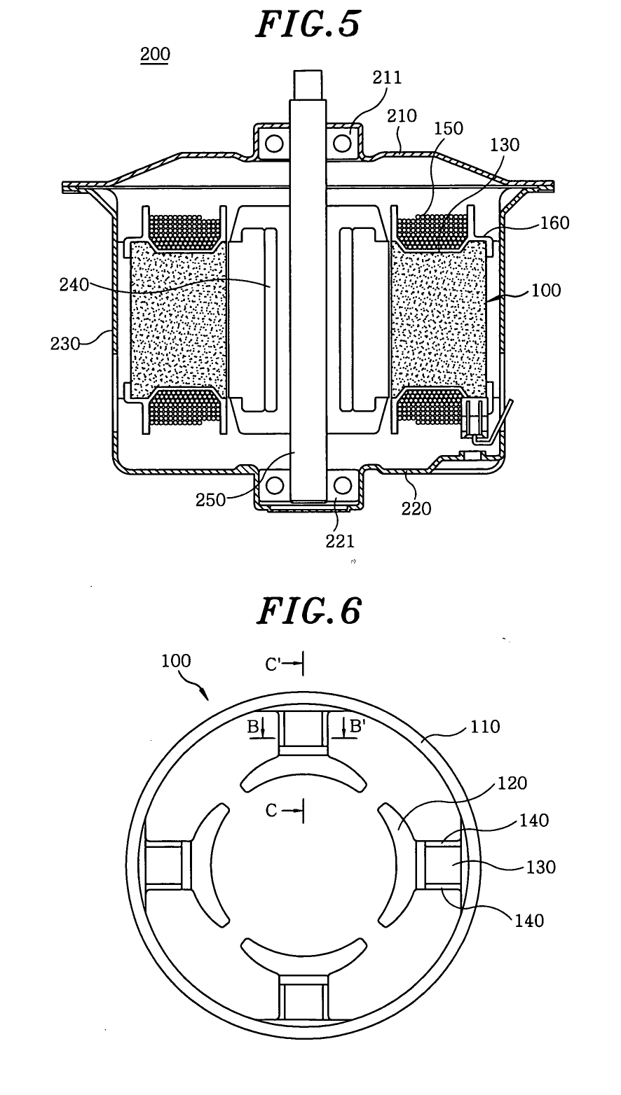

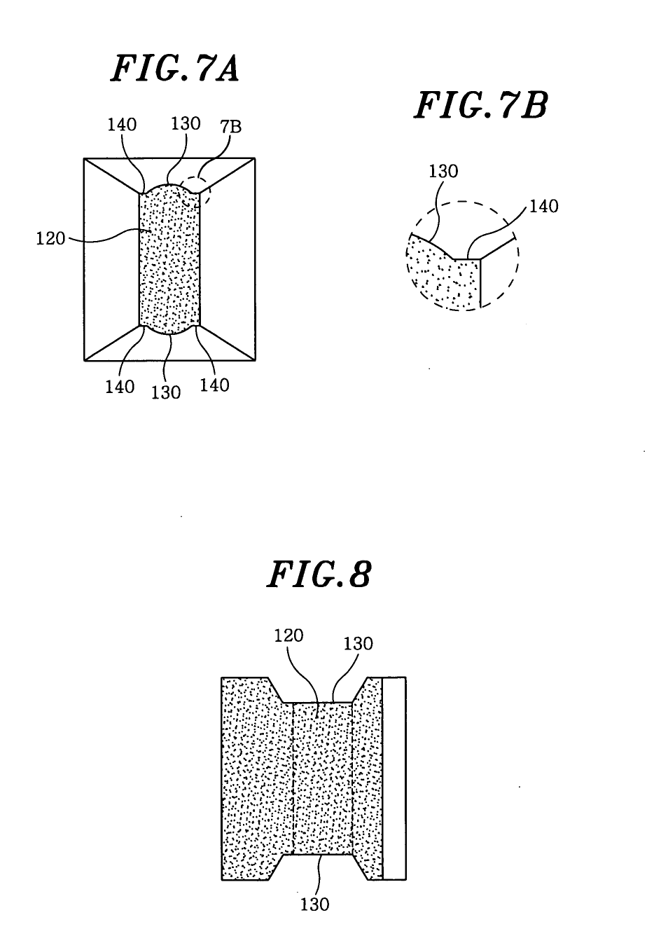

FIG. 5 illustrates a sectional view of a motor in accordance with an embodiment of the present invention. FIG. 6 illustrates a sectional view of a stator used in a motor and formed of a soft magnetic powder material in accordance with a first exemplary embodiment of the present invention. FIG. 7 illustrates a sectional view of the stator taken along a line B-B′ illustrated in FIG. 6. In the motor 200, the stator 100 is affixed to the inner side of a casing 230 to which holders 210 and 220 are individually attached on both sides. A rotor 240 is affixed to a shaft 250 by having a gap therein. The shaft 250 is installed by means of bearings 211 and 221 of the respective holders 210 and 220. The stator 100 includes a main body 110, teeth 120, gap reducers 130, and punch damage barriers 140. The teeth 120 are formed to be integrated with the main body 110. The gap reducers 130 are placed individually on both upper and lower surfaces of each of the teeth 120. The punch damage barriers 140 are formed to extend on both sides of each of the gap reducers 130.

The main body 110 is formed in an annular shape and affixed to the inner surface of the casing 130. The teeth 120 are spaced apart a certain distance from each other on the inner surface of the main body 110, and formed in an integral structure. In the present embodiment, it is exemplified that the teeth 120 are formed on the inner surface of the main body 110. However, the teeth 120 can also be formed on the outer surface of the main body 110 depending on motor types and usage.

A coil 150 is wound around the individual teeth 120 to generate a magnetic filed, and the gap reducers 130 are individually placed on the upper and lower surfaces of each of the teeth 120.

As illustrated in FIG. 7, the gap reducers 130 are formed in the shape of an arc protruding to a direction that reduces gaps between the upper surface of each of the teeth 120 and the coil 150 wound therearound and between the lower surface of each of the teeth 120 and the coil wound therearound. The punch damage barriers 140 are formed to extend to both sides of each of the gap reducers 130. Each of the punch damage barriers 140 has plane surfaces by extending to both sides of the corresponding gap reducer 130 and being connected to both sides of the corresponding tooth 120.

Referring to FIG. 8, the upper and lower surfaces of each of the teeth 120 where the corresponding gap reducer 130 is disposed are indented lengthwise to decrease the volume of the teeth 120 for a lightweight motor.

The stator 100 is molded by pressing soft magnetic powder, which includes iron-based particles each coated with a certain material to be electrically insulated from each other.

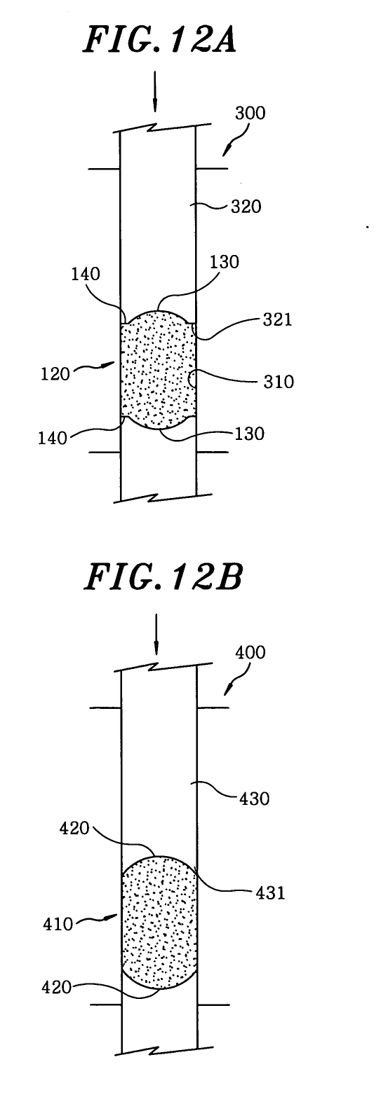

Referring to FIG. 12A, the gap reducers 130 and the punch damage barriers 140 of the stator 100 are manufactured using a press molding apparatus 300. In detail, the press molding apparatus 300 includes a molding space 310 designed to have the same shape as the stator 100. Soft magnetic powder is filled into the molding space 310 and pressed by a pressing member such as a punch 320, thereby forming the gap reducers 130 and the punch damage barriers 140. At this time, a lubricant and/or a bonding agent may be added to the soft magnetic powder and pressed together. FIG. 12A illustrates the press molding of the gap reducers 130 only for the simplicity of the description.

The stator 100 includes a three-dimensional soft magnetic composite (SMC) obtained by pressing the soft magnetic powder, and has a higher degree of freedom as compared with the conventional stator based on silicon steel sheets. Different from the conventional stator having the stack structure of the silicon steel sheets, this high degree of freedom in the three-dimensional structure of the stator 100 allows the formation of the gap reducers 130.

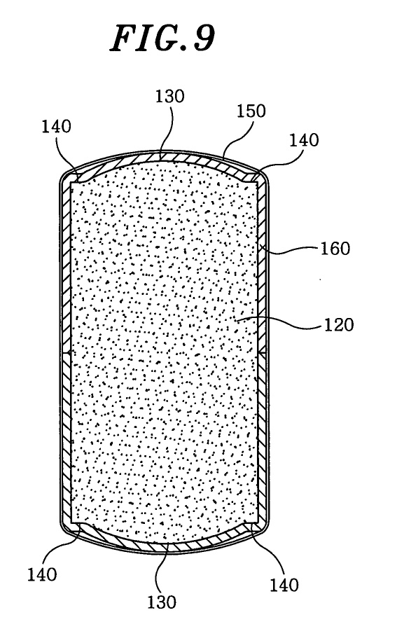

Referring to FIGS. 5 and 9, an insulator 160 is attached to the teeth 120 to insulate the teeth 120 and the coil 150 from each other. Those regions of the insulator 160 contacting the gap reducers 130 and the punch damage barriers 140 are formed in a shape substantially the same as the gap reducers 130 and the punch damage barriers 140.

Referring to FIG. 10, a gap reducer 170 according to a second exemplary embodiment of the present invention is formed to protrude by connecting a straight-line surface portion of the gap reducer 170 with curved-line surface portions thereof. In the second exemplary embodiment, the straight-line surface portion located at a central region of the target surface of the gap reducer 170 is connected with the curved-line surface portions located at both sides of the straight-line surface portion. In addition to this connection, the protrusion of the gap reducer 170 can also achieved through other various connections between the straight-line surface portions with the curved-line surface portions.

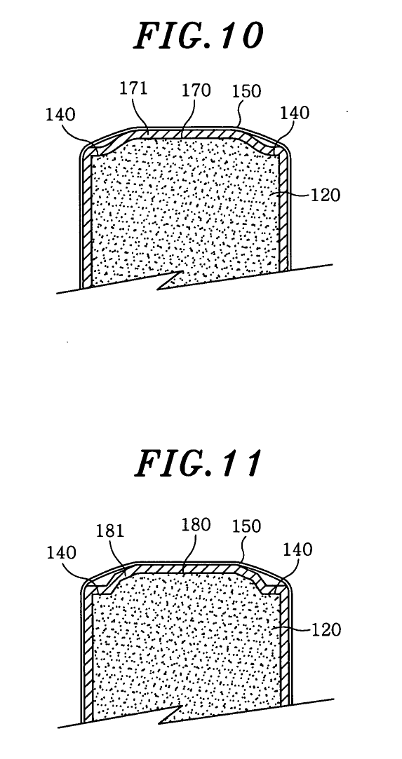

Referring to FIG. 11, a gap reducer 180 according to a third exemplary embodiment of the present invention is formed to protrude by connecting straight-line surface portions with each other.

As similar to the first exemplary embodiment, in the second and third exemplary embodiments, those portions of insulators 171 and 181 contacting the respective gap reducers 170 and 180 and respective punch damage barriers 140 are formed in a shape substantially the same as the gap reducers 170 and 180 and the punch damage barriers 140.

The soft magnetic power-based stator for use in the motor as described above operates as follows.

As illustrated in FIGS. 9 to 11, each of the gap reducers 130, 170 and 180 is formed on both upper and lower surfaces of the corresponding tooth 120, so that gaps each between the upper surface of the corresponding tooth 120 and the coil 150 wound therearound and between the lower surface of the corresponding tooth 120 and the coil 150 wound therearound can be reduced to a greater extent as compared with the conventionally discovered gaps G (see FIG. 4). That is, the teeth 120 are formed to have the width smaller than the height, and thus, when the coil 150 based on a material resistant to a certain degree of bending is wound around the teeth 120, gaps are produced between the upper surface of each of the teeth 120 and the coil 150 wound therearound and between the lower surface of each of the teeth 120 and the coil wound therearound. However, the gap reducers 130, 170 and 180 fill the gaps to thereby reducing sizes of these gaps to a great extent.

As illustrated in FIG. 8, since the teeth 120 are formed to have the indentations lengthwise, the volume of the teeth 120 can be reduced. This volume reduction helps manufacturing of lightweight motors.

As illustrated in FIG. 12A, the punch damage barriers 140 formed in the stator 100 can dull edge portions 321 of the punch 320. Hence, even if the punch 320 presses the soft magnetic powder with great strength to manufacture the stator 100, the punch damage barriers 140 can contribute to improvement in durability of the punch 320.

Meanwhile, as illustrated in FIG. 12B, for a tooth 410 without punch damage barriers with plane surfaces, gap reducers 420 that protrude in curvature are connected directly to both sides of the tooth 410. Thus, edge portions 431 of a punch 430 of a press molding apparatus 400 are sharp, and as a result, the edge portions 431 are likely to be damaged when soft magnetic powder is pressed. Accordingly, the punch damage barriers 140 can prevent damage to the punch 320 of the press molding apparatus 300.

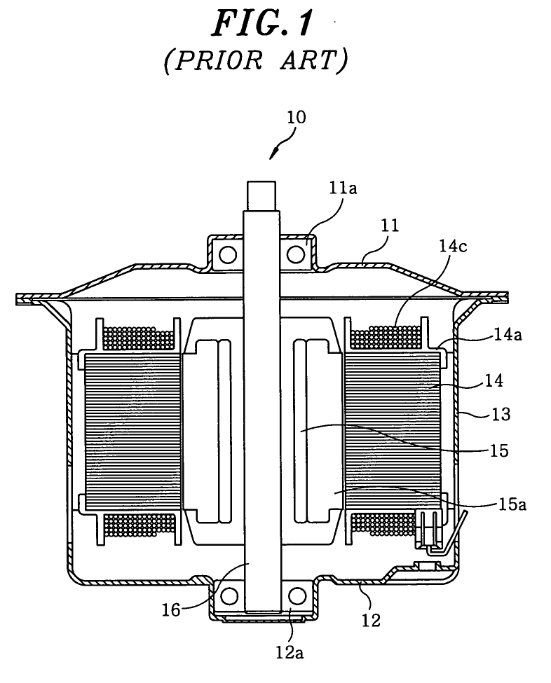

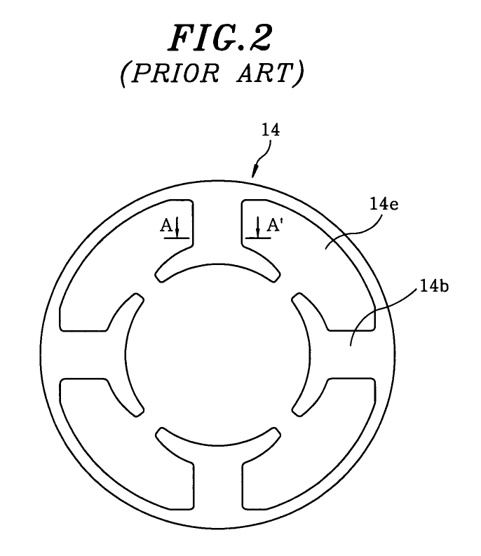

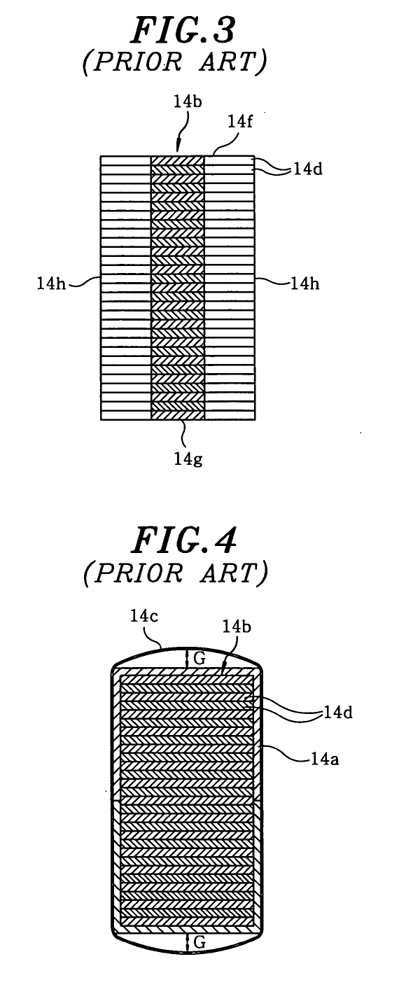

Different from the conventional stator 14 (see FIG. 1) formed by stacking the silicon steel sheets 14d (see FIG. 3) over each other, the soft magnetic powder-based stator 100 for use in the motor 200 allows formation of the gap reducers 130, 170 and 180 due to the use of the soft magnetic powder. The gap reducers 130, 170 and 180 can reduce the gaps between each of the teeth 120 and the coil 150. As a result, efficiency of the motor 200 can be improved, thereby further facilitating the performance of the motor 200.

Also, since the coil 150 is disposed close to the individual teeth 120, an amount of the coil 150 used can be reduced as compared with the amount of the coil 14c of the motor 10 (see FIG. 1) having the same number of windings as the coil 150 of the motor 200. This reduction allows manufacturing of the motor 200 at low cost. Since the teeth 120 are indented lengthwise, the motor 200 can be lightweight. Furthermore, it is possible to minimize damage to those parts of the manufacturing equipment, e.g., the punch 220.

On the basis of various embodiments of the present invention, the performance of the motor can be improved by reducing gaps between each of the teeth and the coil. Also, the manufacturing costs can be reduced by decreasing an amount of the coil used. The decrease in the volume of the teeth allows manufacturing of the lightweight motor, and damage to the parts of the manufacturing equipment can be minimized.

While the invention has been shown and described with respect to the preferred embodiments, it will be understood by those skilled in the art that various changes and modifications may be made without departing from the spirit and scope of the invention as defined in the following claims.

What is claimed is:

1. A stator for use in a motor, being wound with a coil, the stator comprising:
a main body fixed to a inside of the motor;
a plurality of teeth formed to be integrated with the main body and respectively wound with the coil;
gap reducers, each of which being formed on upper and lower surfaces of each of the teeth and protruding in a direction to decrease gaps between an upper surface of each of the teeth and the coil and between a lower surface of each of the teeth and the coil; and
punch damage barriers, each of which having plane surfaces extending to both sides of each of the gap reducers and connected to both sides of each of the teeth,
wherein the stator is manufactured by pressing soft magnetic powder.

2. The stator of claim 1, wherein the teeth are formed to have indentations lengthwise on the upper and lower surfaces of the teeth to decrease a volume of the teeth.

3. The stator of claim 1, wherein each of the gap reducers is formed in an arc shape to protrude.

4. The stator of claim 1, wherein each of the gap reducers is formed to protrude by connecting a straight-line surface portion of each of the gap reducers with curved-line surface portions of each of the gap reducers.

5. The stator of claim 1, wherein each of the gap reducers is formed to protrude by connecting straight-line surface portions of each of the gap reducers with each other.
